(19) United States
(12) Patent Application Publication
(10) Pub. No.: US 2015/0153715 A1
(43) Pub. Date: Jun. 4, 2015

(54) RAPIDLY PROGRAMMABLE LOCATIONS IN SPACE

(71) Applicant: Google Inc., (US)

(72) Inventors: Alejandro Kauffmann, San Francisco, CA (US); Aaron Joseph Wheeler, San Francisco, CA (US); Liang-Yu Chi, San Francisco, CA (US); Hendrik Dahlkamp, San Francisco, CA (US); Varun Ganapathi, Palo Alto, CA (US); Yong Zhao, San Jose, CA (US); Christian Plagemann, Menlo Park, CA (US)

(73) Assignee: Google Inc., Mountain View, CA (US)

(21) Appl. No.: 13/669,876

(22) Filed: Nov. 6, 2012

Related U.S. Application Data
(63) Continuation-in-part of application No. 13/572,128, filed on Aug. 10, 2012.

(51) Int. Cl. G05B 15/02; H04N 13/02

(52) U.S. Cl. CPC G05B 15/02

(57) ABSTRACT

Aspects of the present disclosure relate to controlling the functions of various devices based on spatial relationships. In one example, a system may include a depth and visual camera and a computer (networked or local) for processing data from the camera. The computer may be connected (wired or wirelessly) to any number of devices that can be controlled by the system. A user may use a mobile device to define a location in space relative to the camera. The location in space may then be associated with a controlled device as well as one or more control commands. When the location in space is subsequently occupied, the one or more control commands may be used to control the controlled device. In this regard, a user may switch a device on or off, increase volume or speed, etc. simply by occupying the location in space.

### CROSS-REFERENCE TO RELATED APPLICATIONS

The present application is a continuation-in-part of U.S. patent application Ser. No. 12/893,204, filed on Sep. 29, 2010, the disclosure of which is incorporated herein by reference.

### BACKGROUND OF THE INVENTION

Various systems allow for the determination of distances and locations of objects. For example, depth cameras systems may use a light source, such as infrared light, and an image sensor. The pixels of the image sensor receive light that has been reflected off of objects. The time it takes for the light to travel from the camera to the object and back to the camera is used to calculate distances. Typically these calculations are performed by the camera itself.

Depth cameras have been used for various computing purposes. Recently, these depth camera systems have been employed as part of gaming entertainment systems. In this regard, users may move their bodies and interact with the entertainment system without requiring a physical, hand-held controller.

### SUMMARY

One aspect of the disclosure provides method. The method includes receiving input defining a location; receiving input identifying a controlled device; receiving input defining a control command for the controlled device; associating the location, the controlled device, and the control command; storing the association in memory; receiving information identifying the location, the received information indicating that the location is newly occupied by an object; in response to the received information, accessing the memory to identify the control command and the controlled device associated with the location; and using, by a processor, the control command to control the controlled device.

In one example, the location includes only a single point in three-dimensional space and the method also includes monitoring the single point to determine when the single point is occupied by the object. In another example, the location includes a line defined by two points and the method also includes monitoring the line defined by the two points to determine when the line defined by the two points is occupied by the object. In another example, the location includes a two-dimensional area and the method also includes monitoring the two-dimensional area to determine when the single point is occupied by the object. In another example, the location is defined by receiving input to capture a single point in three-dimensional space. In another example, the location is defined by receiving input to capture a first point and a second point and drawing a line between the first point and the second point to define the location. In another example, the location is defined by receiving input to capture a first point, a second point, and a third point, and drawing an area using the first point, the second point, and the third point to define the location.

In another example, the input defining the location is received from a depth camera. In this example, the location is defined relative to a coordinate system of the depth camera. Alternatively, the location is defined relative to an object other than the depth camera such that if the object is moved, the location with respect to the depth camera is moved as well. In this example, the object includes at least some feature of a user's body.

Another aspect of the disclosure provides a system. The system includes memory and a processor. The processor is configured to receive input defining a location; receive input identifying a controlled device; receive input defining a control command for the controlled device; associate the location, the controlled device, and the control command; store the association in the memory; receive information identifying the location, the received information indicating that the location is newly occupied by an object; in response to the received information, access the memory to identify the control command and the controlled device associated with the location; and use the control command to control the controlled device.

In one example, the location includes only a single point in three-dimensional space and the processor is also configured to monitor the single point to determine when the single point is occupied by the object. In another example, the location includes a line defined by two points and the processor is further configured to monitor the line defined by the two points to determine when the line defined by the two points is occupied by the object. In another example, the location includes a two-dimensional area and the processor is also configured to monitor the two-dimensional area to determine when the single point is occupied by the object. In another example, the processor is also configured to define the location by receiving input to capture a single point in three-dimensional space. In another example, the processor is also configured to define the location by receiving input to capture a first point and a second point and drawing a line between the first point and the second point to define the location. In another example, the processor is also configured to define the location by receiving input to capture a first point, a second point, and a third point and drawing an area using the first point, the second point, and the third point to define the location.

A further aspect of the disclosure provides a non-transitory, tangible computer-readable storage medium on which computer readable instructions of a program are stored. The instructions, when executed by a processor, cause the processor to perform a method. The method includes receiving input defining a location; receiving input identifying a controlled device; receiving input defining a control command for the controlled device; associating the location, the controlled device, and the control command; storing the association in memory; receiving information identifying the location, the received information indicating that the location is newly occupied by an object; in response to the received information, accessing the memory to identify the control command and the controlled device associated with the location; and using the control command to control the controlled device.

### BRIEF DESCRIPTION OF THE DRAWINGS

FIG. 1 is a functional diagram of a system in accordance with aspects of the disclosure.

FIG. 2 is a pictorial diagram of the system of FIG. 1.

FIG. 3 is a diagram of an example room in accordance with aspects of the disclosure.

FIG. 4 is another diagram of an example room in accordance with aspects of the disclosure.

FIG. 5 is an example of defining a location in space in accordance with aspects of the disclosure.

FIG. 6 is a diagram of an example room in accordance with aspects of the disclosure.

FIG. 7 is an example of defining a location in space in accordance with aspects of the disclosure.

FIG. 8 is another example of defining a location in space in accordance with aspects of the disclosure.

FIG. 9 is a further example of defining a location in space in accordance with aspects of the disclosure.

FIG. 10 is yet another example of defining a location in space in accordance with aspects of the disclosure.

FIG. 11 is an example of a client device and display in accordance with aspects of the disclosure.

FIG. 12 is a diagram of an example room in accordance with aspects of the disclosure.

FIG. 13 is another diagram of an example room in accordance with aspects of the disclosure.

FIG. 14 is a further diagram of an example room in accordance with aspects of the disclosure.

FIG. 15 is yet another diagram of an example room in accordance with aspects of the disclosure.

FIG. 16 is another diagram of an example room in accordance with aspects of the disclosure.

FIG. 17 is a flow diagram in accordance with aspects of the disclosure.

FIG. 18 is a diagram of an example room in accordance with aspects of the disclosure.

FIG. 19 is another diagram of an example room in accordance with aspects of the disclosure.

FIG. 20 is a further diagram of an example room in accordance with aspects of the disclosure.

FIG. 21 is yet another diagram of an example room in accordance with aspects of the disclosure.

### DETAILED DESCRIPTION

In one example, input defining a location in space, a controlled device, and a control command for the controlled device may be received. These locations in space may include for example, single points, lines (between two points), two-dimensional areas, and 3-dimensional volumes. These inputs may be received in various ways as received in more detail below. The location in space, the controlled device, and the control command may be associated with one another, and the associations may be stored in memory for later use.

The location in space may be monitored to determine when it is occupied. When the location in space is occupied, the control command and controlled device associated with the volume of space may be identified. The control command may then be used to control the controlled device.

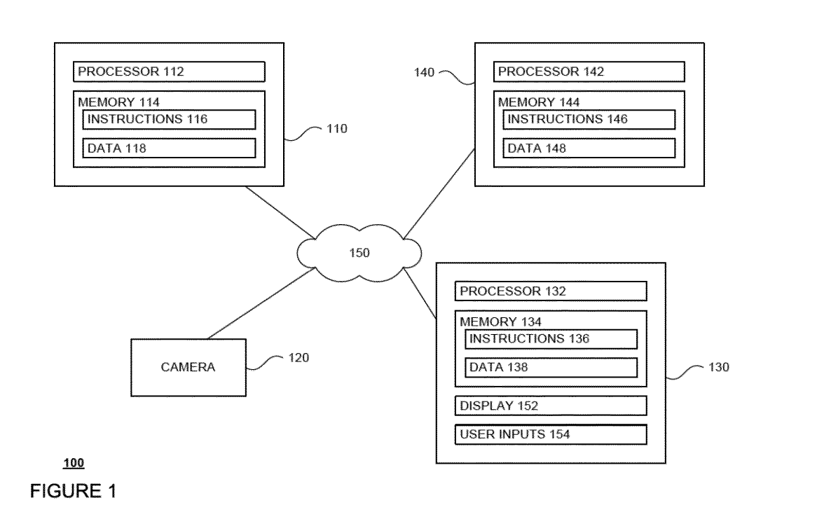

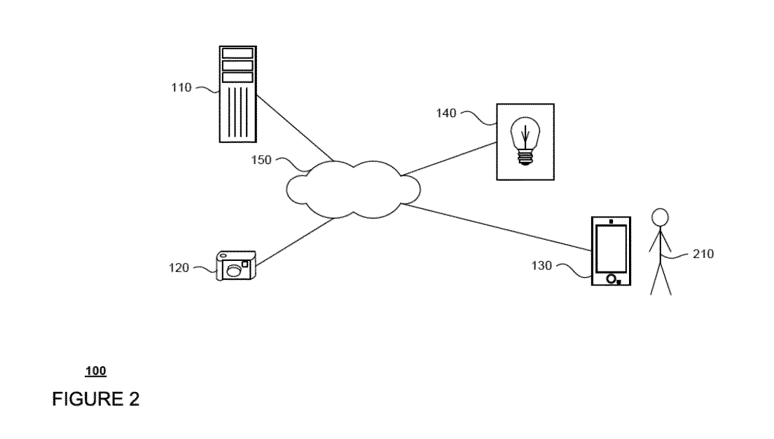

As shown in FIGS. 1-2, an exemplary system 100 may include devices 110, 120, 130, and 140. Device 110 may include a computer having a processor 112, memory 114 and other components typically present in general purpose computers. Memory 114 of computer 110 may store information accessible by processor 112, including instructions 116 that may be executed by the processor 112.

Memory may also include data 118 that may be retrieved, manipulated or stored by the processor. The memory may be of any type capable of storing information accessible by the processor, such as a hard-drive, memory card, ROM, RAM, DVD, CD-ROM, write-capable, and read-only memories.

The instructions 116 may be any set of instructions to be executed directly (such as machine code) or indirectly (such as scripts) by the processor. In that regard, the terms “instructions,” “application,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data 118 may be retrieved, stored or modified by processor 112 in accordance with the instructions 116. For instance, although the system and method is not limited by any particular data structure, the data may be stored in computer registers, in a relational database as a table having a plurality of different fields and records, or XML documents. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information that is used by a function to calculate the relevant data.

The processor 112 may be any conventional processor, such as commercially available CPUs. Alternatively, the processor may be a dedicated device such as an ASIC or other hardware-based processor. Although FIG. 1 functionally illustrates the processor, memory, and other elements of computer 110 as being within the same block, it will be understood by those of ordinary skill in the art that the processor, computer, or memory may actually comprise multiple processors, computers, or memories that may or may not be stored within the same physical housing. For example, memory may be a hard drive or other storage media located in a housing different from that of computer 110. Accordingly, references to a processor, computer, or memory will be understood to include references to a collection of processors, computers, or memories that may or may not operate in parallel.

The computer 110 may be at one node of a network 150 and capable of directly and indirectly communicating with other nodes, such as devices 120, 130, and 140 of the network. The network 150 and intervening nodes described herein, may be interconnected via wires and/or wirelessly using various protocols and systems, such that each may be part of the Internet, World Wide Web, specific intranets, wide area networks, or local networks. These may use standard communications protocols or those proprietary to one or more companies, Ethernet, WiFi, HTTP, ZigBee, Bluetooth, infrared (IR), etc., as wells various combinations of the foregoing.

In one example, device 120 may comprise a camera. The camera 120 may capture visual information in the form of video, still images, etc. In addition, camera 120 may include features that allow the camera (or computer 110) to determine the distance from and relative location of objects captured by the camera. In this regard, the camera 120 may include a depth camera that projects infrared light and generates distance and relative location data for objects based on when the light is received back at the camera, though other types of depth cameras may also be used. This data may be pre-processed by a processor of camera 120 before sending to computer 110 or the raw data may be sent to computer 110 for processing. In yet another example, camera 120 may be a part of or incorporated into computer 110.

Device 130 may comprise a client device configured to allow a user to program locations in space. As noted above, these locations in space may include, for example, discrete points, lines (between two points), two-dimensional areas, and 3-dimensional volumes.

Client device 130 may be configured similarly to the computer 110, with a processor 132, memory 134, instructions 136, and data 138 (similar to processor 112, memory 114, instructions 116, and data 118). Client device 120 may be a personal computer, intended for use by a user 210 having all the components normally found in a personal computer such as a central processing unit 132 (CPU), display device 152 (for example, a monitor having a screen, a projector, a touch-screen, a small LCD screen, a television, or another device such as an electrical device that is operable to display information processed by the processor), CD-ROM, hard-drive, user inputs 154 (for example, a mouse, keyboard, touch-screen or microphone), camera, speakers, modem and/or network interface device (telephone, cable or otherwise) and all of the components used for connecting these elements to one another. For example, a user may input information into client device 130 via user inputs 154, and the input information may be transmitted by CPU 132 to computer 110. By way of example only, client device 130 may be a wireless-enabled PDA, hand-held navigation device, tablet PC, netbook, music device, or a cellular phone.

Device 140 may be any device capable of being controlled by computer 110. As with client device 130, controlled device 140 may be configured similarly to the computer 110, with a processor 142, memory 144, instructions 146, and data 148 (similar to processor 112, memory 114, instructions 116, and data 118). For example, controlled device 140 may comprise a lamp which may be switched on or off in response to receiving instructions from computer 110. Similarly, controlled device 140 may comprise a separate switching device which interacts with computer 110 in order to control power to the lamp. Controlled device 140 may comprise or be configured to control operation (including, for example, powering on and off, volume, operation modes, and other operations) of various other devices such as televisions, radio or sound systems, fans, security systems, etc. Although the example of FIGS. 1 and 2 depicts only a single controlled device, computer 110 may be in communication with a plurality of different devices. Moreover, devices and computers in accordance with the systems and methods described herein may comprise any device capable of processing instructions and transmitting data to and from humans and other computers including general purpose computers, PDAs, network computers lacking local storage capability, set-top boxes for televisions, and other networked devices.

Returning to FIG. 1, data 118 of computer 110 may store information relating a location in space, a controlled device (such as device 140), and one or more control commands. This data may be stored in a database, table, array, etc. This information may be stored such that when a location in space is identified, computer 110 may in turn identify a controlled device and one or more control commands. In addition, a single location in space may be associated with multiple controlled devices with different control commands for each of the multiple controlled devices.

Although some functions are indicated as taking place on a single computer having a single processor, various aspects of the system and method may be implemented by a plurality of computers, for example, communicating information over network 150. In this regard, computer 110 may also comprise a web server capable of communicating with the devices 120, 130, 140. Server 110 may also comprise a plurality of computers, e.g., a load balanced server farm, that exchange information with different nodes of a network for the purpose of receiving, processing and transmitting data to the client devices. In this instance, the client devices will typically still be at different nodes of the network than any of the computers comprising server 110.

In addition to the operations described below and illustrated in the figures, various operations will now be described. It should also be understood that the following operations do not have to be performed in the precise order described below. Rather, various steps may be handled in a different order or simultaneously. Steps may also be omitted unless otherwise stated.

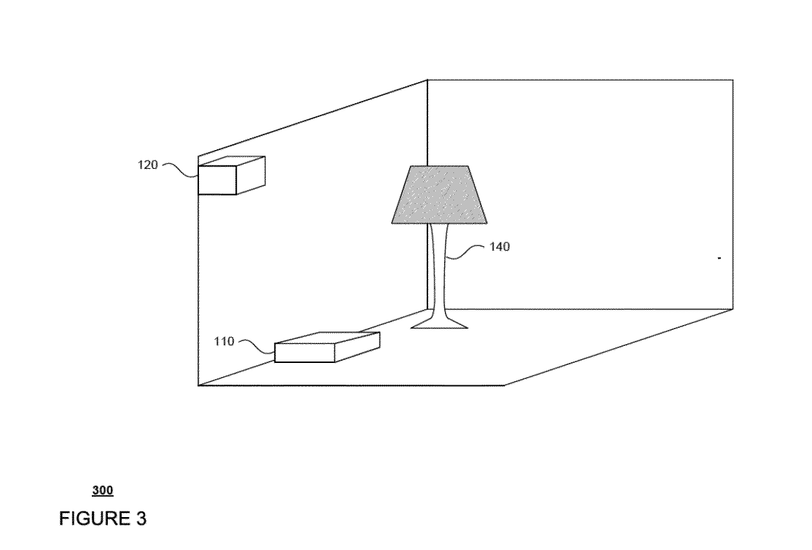

FIG. 3 depicts a room 300 having a computer 110, depth camera 120, and a controlled device 140. The camera is placed in a room in an appropriate location in order to allow the camera to capture spatial information about the room. Although only a single controlled device is depicted in room 300, computer 110 may be connected (wired or wirelessly) to any number of controlled devices that can be controlled by the computer. In addition, computer 110 is shown as being proximate to depth camera 120, but, as noted above, computer 110 may be networked in order to interact with depth camera 120. Again, computer 110 and depth camera 120 are configured such that depth camera 120 may send data about room 300 to computer 110.

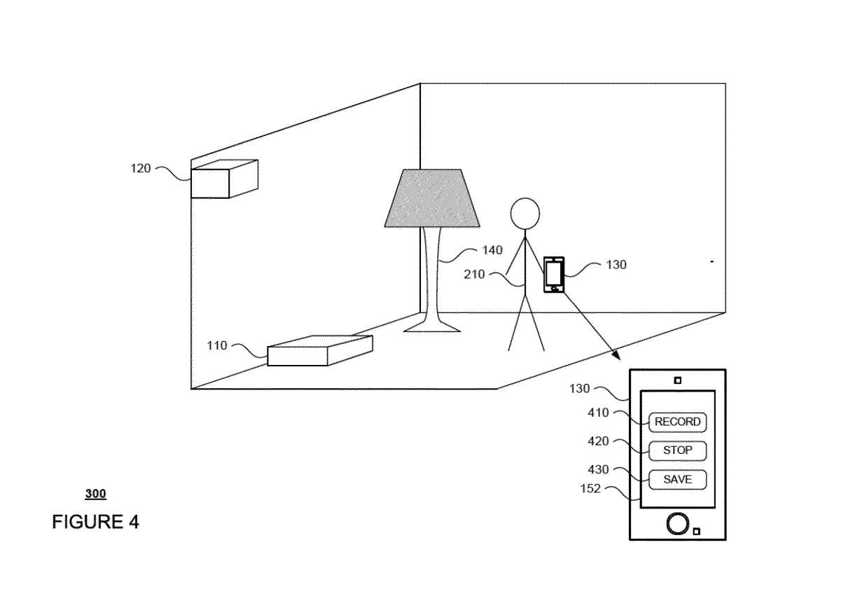

A client device may be used to define locations in space in a room or other location. As shown in FIG. 4, a user 210 may hold client device 130 in a position such that the client device 140 is visible to the depth camera 120. The user may then indicate to the depth camera 120 that a location in space is going to be defined. For example, user 210 may use the user inputs of the client device 130 to select a record option 410. The client device may then transmit a signal to the depth camera 120 to begin defining a location in space. Alternatively, the timing of the recording may be input into computer 110 or determined automatically (by identifying some signal from client device 130) at computer 110.

In one example, the user 210 may simply define a single point as a location in space. For example, referring to FIG. 4, the user 210 may use the record option 410 when the client device is at a particular location. In this regard, the user may “capture” the position of the client device by using the record option 410. The client device or depth camera may then identify a particular point relative to the client device at the time and location of the capture. This particular point may be defined by a corner of the client device or at some location relative to the display 152 (such as the center or other location on the display). The location in space of the particular point may then be determined relative to an absolute coordinate system defined by the depth camera 120.

In another example, the user 210 may also define a location of space by moving the client device 130 between different locations. In one example, similar to that discussed above, user 210 may “capture” multiple points by moving client device 120 and using the record option 410 as described above. These multiple points may then be used to define the location in space. Alternatively, as the client device 130 is moved, the movements may be continuously recorded by the depth camera 120 and sent to the computer 110. In this regard, the depth camera 120 may track the location of an image on the display 15 of client device 120 relative to an absolute coordinate system defined by the depth camera 120. The image may include a particular color block, displayed object, QR code, etc. When the user is finished, user 210 may use the user inputs of the client device 130 to select a stop and/or save option (see stop option 420 and save option 430 of FIG. 4).

In one example, the location in space may include a line between two points. In this regard, a user may define the two points, for example, using the method described above. These points may be connected to form the line. The location in space of the line may then be determined relative to an absolute coordinate system defined by the depth camera 120.

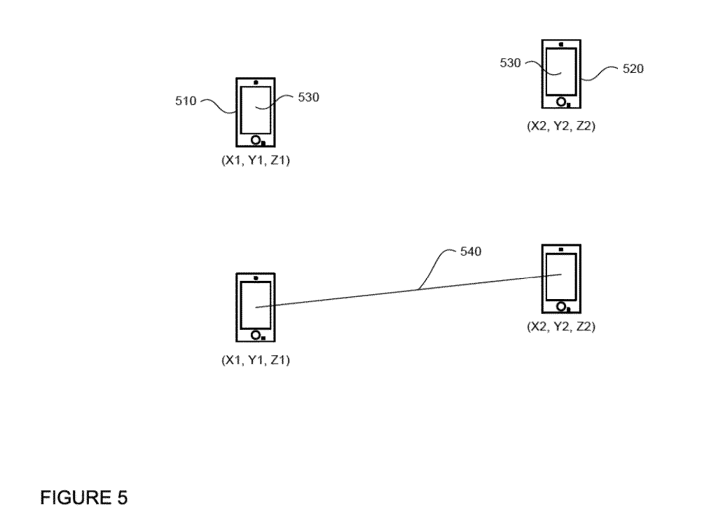

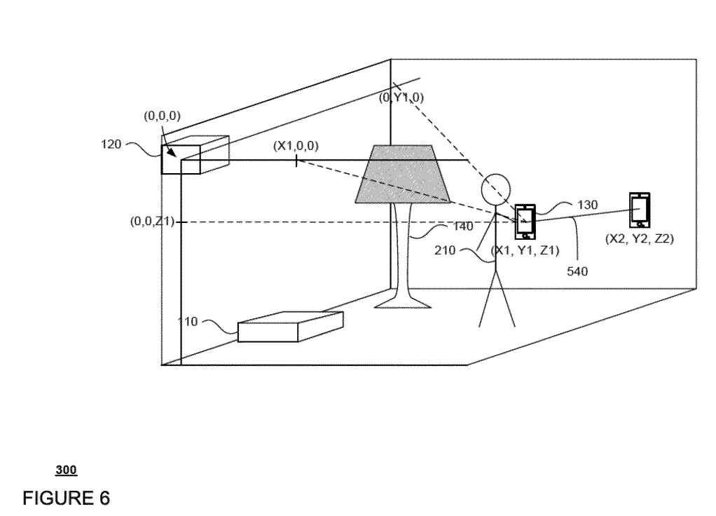

FIG. 5 is an example of a user defining a location in space as a line between two points. For instance, a user may capture the location of client device 130 at location 510 and subsequently at location 520. A point relative to the screen of the client device, such as point 530, may be tracked by the depth camera. The relative location of point 530 at location 510 to the depth camera, or location (X1, Y1, Z1), may be defined as a first end point of a line. The relative location of point 530 at location 520 to the depth camera, or location (X2, Y2, Z2), may be defined as a second end point of a line 540. The line 540 between these points may then be used as a location in space. FIG. 6 illustrates the points 510, 520 as well as line 540 in the coordinate system relative to depth camera 120.

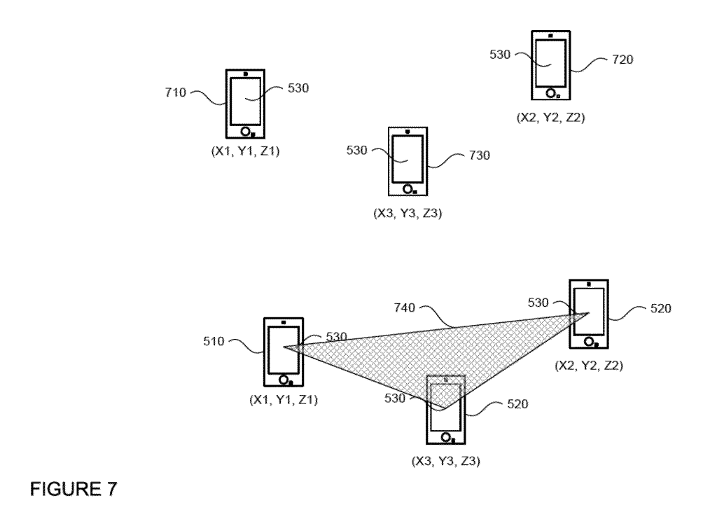

In another example, the location in space may include an area, surface, or a plane. In this example, the user may define at least three points in space. These three points may be used to form a two-dimensional shape (such as a closed area or a portion of a plane. The two-dimensional shape may also be thought of as a volume with an infinitely small third dimension. FIG. 7 is an example of a location in space being defined as a area formed by three points in space.

For example, a user may capture the location of client device 130 at locations 710, 720, and 730, and subsequently at location 720. A point relative to the screen of the client device, such as point 530, may be tracked by the depth camera. The relative location of point 530 at location 710 to the depth camera, or location (X1, Y1, Z1), may be defined as a point of a plane. The relative location of point 530 at location 720 to the depth camera, or location (X2, Y2, Z2), may be defined as a second point in a plane. The relative location of point 530 at location 730 to the depth camera, or location (X3, Y3, Z3), may be defined as a second end point of a line. These three locations, (X1, Y1, Z1), (X2, Y2, Z2), and (X3, Y3, Z3), may be connected to form a plane 740. In the example of FIG. 7, two-dimensional area 740 is drawn by connecting the locations using straight lines. Other shapes, such as curves or ovals may be used to define a two-dimensional area.

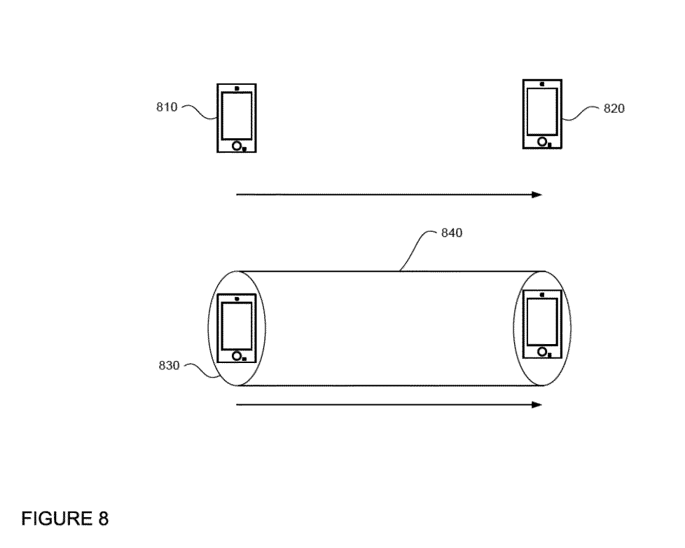

Various movements may be used to define a location in space as a three-dimensional volume of space. FIG. 8 depicts on example of how a volume of space may be defined. In this example, a user may simply move the client device 120 from a first location 810 to a second location 820 during the recording. A two or three-dimensional shape such as a circle 530, sphere, or other shape may then be drawn around the client device (for example, by computer 110 or depth camera 120) and used to define the three-dimensional volume of space 840.

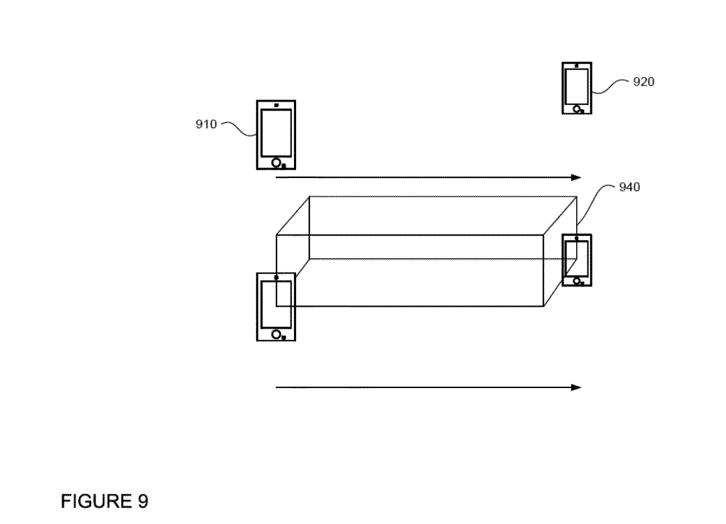

In the example of FIG. 9, a user may identify a first location 910 and a second location 920 during the recording. These two locations may be used as the corners of a cuboid which represents a three-dimensional volume of space 940. FIG. 8 depicts yet another example of how a three-dimensional volume of space may be defined. In this example, user 210 may move the client device 130 to define a closed shape 1010 (the starting and ending points are the same). This closed shape 1010 may then be rotated around an axis (such as axis 1020 through the starting and ending points) to generate a three-dimensional version 1040 of the closed shape 1010 which represents the volume of space 1040. This axis may also be outside of the closed shape, and may also be input or otherwise identified by a user. Alternatively, the volume may be defined by the closed shape itself such that no additional rotation is required.

The location data captured by the depth camera 210 and defined by the user is then sent to the computer 110. Computer 110 may process the data to define a particular location in space. As noted above the tracked location may be processed by a processor of the depth camera and sent to the computer 110, or the raw data collected by the depth camera may be sent to computer 110 for processing. In yet another alternative, the depth camera 120 may also determine the location in space and its relative location to the absolute coordinate system and send all of this information to computer 110.

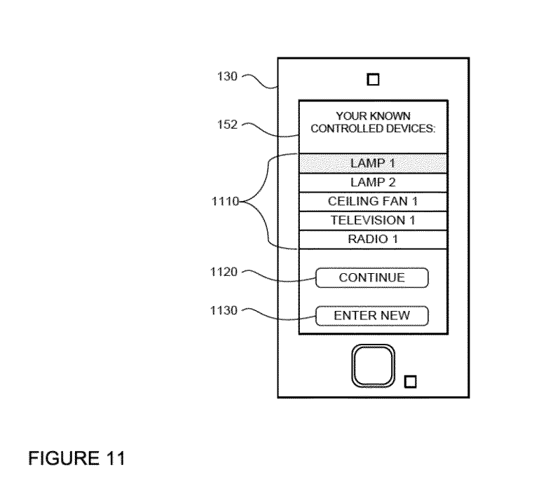

A user may input data identifying a controlled device. In one example, user 210 may input at the inputs 152 of the client device 130 to select or identify controlled device 140 as shown in FIG. 11. For example, display 152 may display a list 1110 of controlled devices which are previously known to computer 110. In this example, “Lamp 1”, the name associated with controlled device 140 of FIG. 4, is shown as selected. The user may then continue by selecting option 1120 or input a new controlled device by selecting option 1130.

Once the controlled device is identified, the user may select or input one or more control commands. In one example, the location in space may represent an on/off toggle for the selected or identified controlled device. In this regard, using the example of the lamp, the control command may instruct the light to be turned on or off. These control commands, the identified controlled device, and the location in space may be associated with one another and stored at computer 110.

Once this data and associations are stored, the location in space may be monitored to determine whether a stored location in space is occupied. This monitoring may be performed by a depth camera or other device based on the geometric characteristics of the location in space (e.g., point, line between two points, two-dimensional surface or plane, or three-dimensional volume. Whether or not a location in space is actually occupied may be determined by the camera 120 and this information subsequently sent to computer 110. Alternatively, the camera 120 may continuously send all of or any changes the distance and location information determined or collected by the camera to computer 110. In this example, the determination of whether a location in space is newly occupied may be made by computer 110.

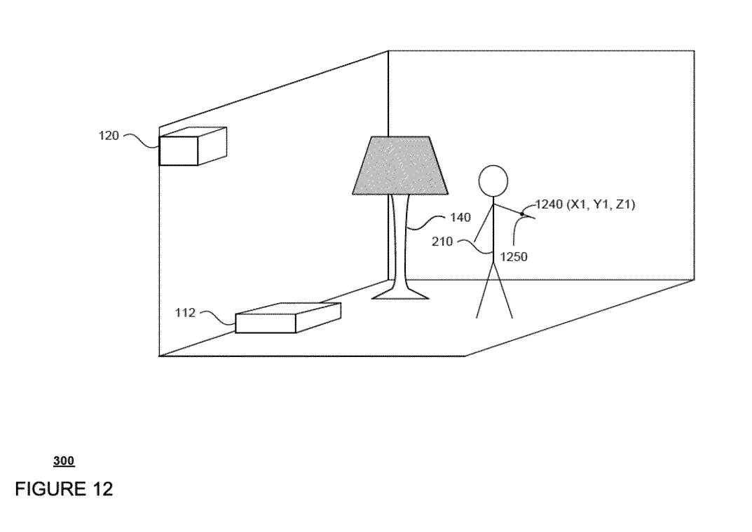

The monitoring may include determining whether an object is newly occupying the location in space. For example, an object such as user 210's body may be identified as occupying a location in space based on the physical location of user 210 with respect to the depth camera 120. With regard to the example of a location in space including only a single point, the state of this point may be monitored to determine whether the location in space is occupied. If an object moves through or into that point, the location may be determined to be occupied. Turning to the example of FIG. 12, location in space 1240 includes only point (X1, Y1, Z1). Depth camera 120 may monitor this particular point. As shown in FIG. 12, user 210 may walk into or around room 300 and the arm 1250 of user 210 may pass through point (X1, Y1, Z1), and thus, depth camera 120 may determine that location in space 1240 is occupied.

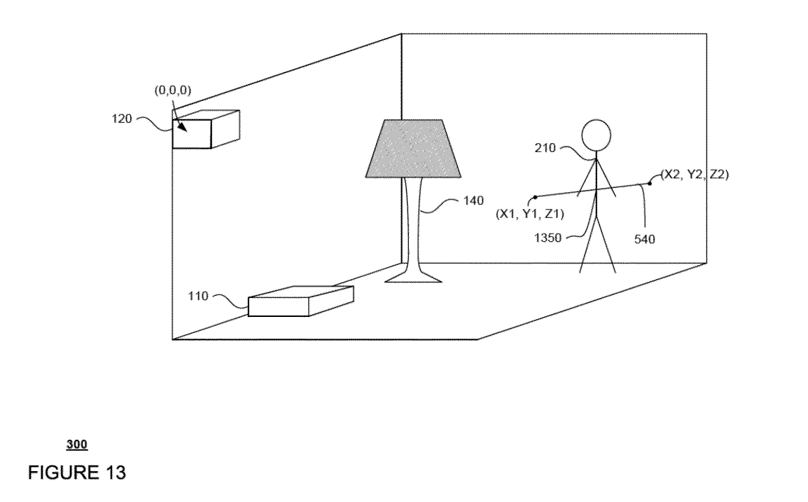

In the example of a location in space including a line between two points, the line may act as a “trip wire.” In this regard, the depth camera 120 may monitor the state of a line such as line 540 of FIG. 5 (or FIG. 6). If an object passes through the line (in other words, if the line has been “tripped”), the depth camera may determine that this location in space is occupied. This determination of occupation may be made if an object passes through any portion of line 540. As shown in the example of FIG. 13, user 210's torso 1350 passes through and “trips” line 540. Accordingly, depth camera may determine that the location in space that includes line 540 is occupied.

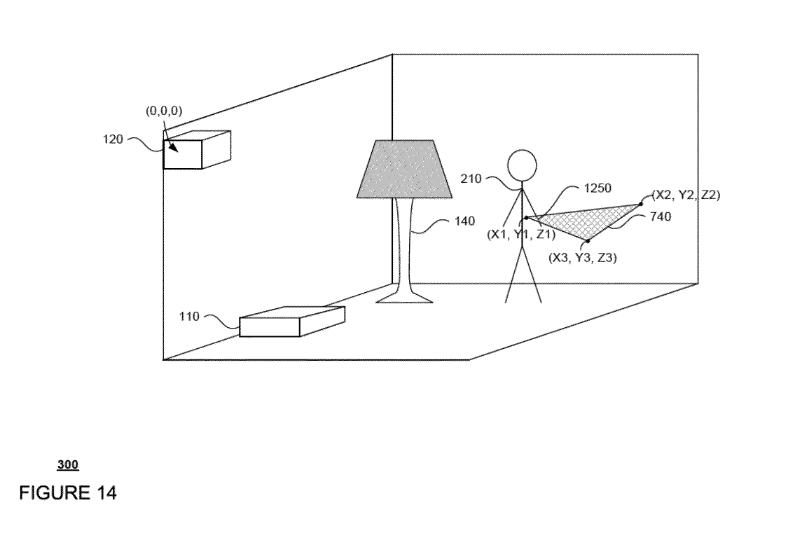

In the example of a location in space including a two-dimensional surface or plane, again, this area may be monitored to determine whether the location in space is occupied. In this regard, the depth camera 120 may monitor the state of an area such as area 740 of FIG. 7. If an object passes through the area, the depth camera may determine that this location in space is occupied. As shown in FIG. 14, the arm 1250 of user 210 passes through area 740, and thus depth camera 120 may determine that location in space that includes area 740 is occupied.

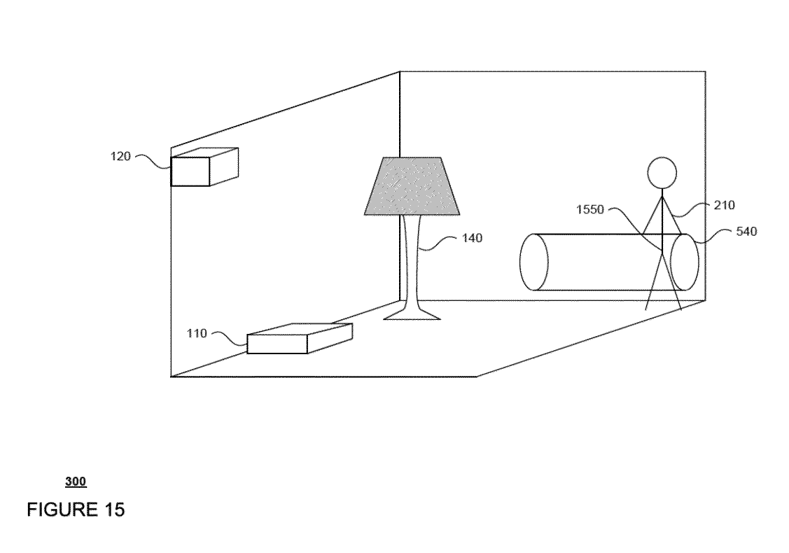

In the example of a location in space including a three-dimensional volume of space, the three-dimensional volume may be monitored to determine whether the location in space is occupied. In this regard, the depth camera 120 may monitor the state of a three-dimensional volume of space such as volume of space 840 of FIG. 8. In the example of FIG. 15, a portion of user 210's body 1550 passes through volume of space 840. Accordingly, depth camera 120 may determine that location in space that includes volume of space 840 is occupied.

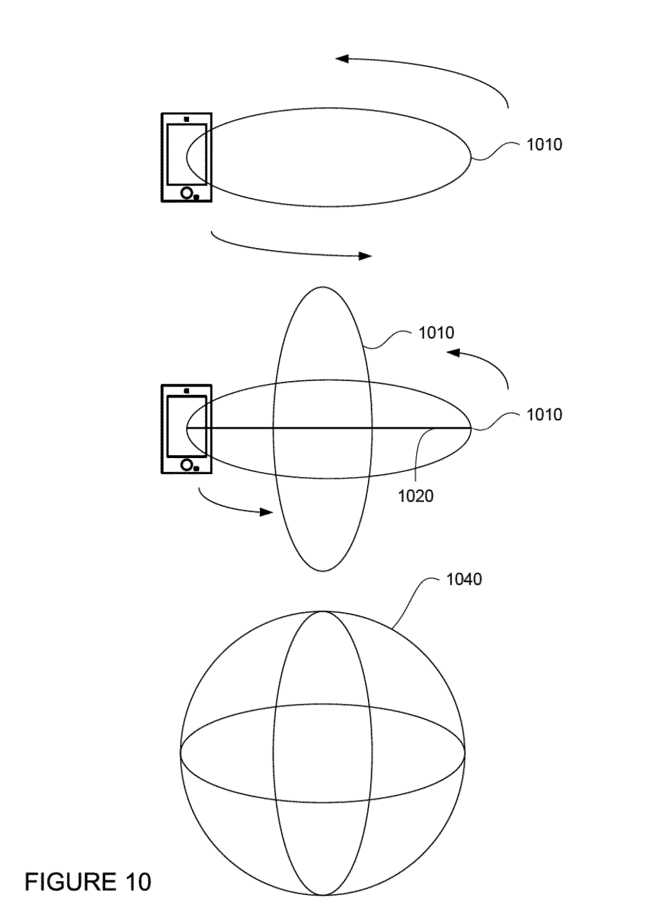

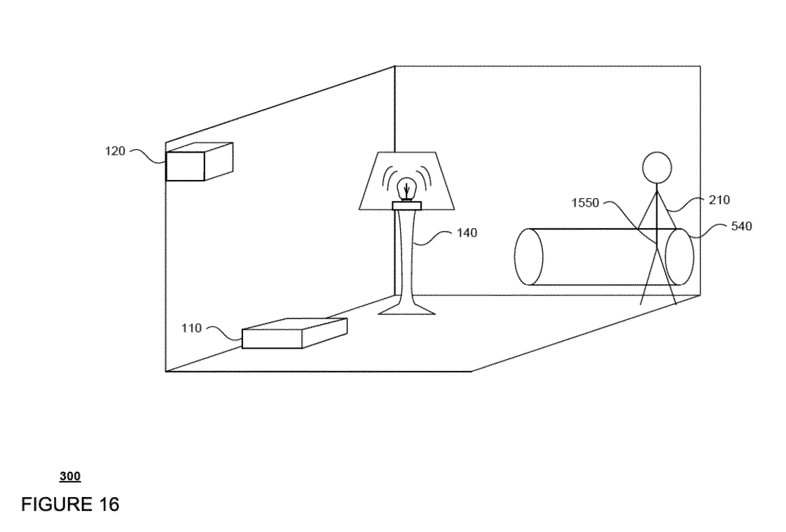

Once it is determined that a location in space is occupied, the one or more control commands associated with the location in may be identified. In one example, the control command may be to turn on or off controlled device 140, or the lamp depicted in room 300. This information is then sent to the controlled device 140 to act upon the control command. Returning to the example of FIG. 10, when the portion of the body 1550 of user 210 passes through volume of space 540, such as when user 210 enters room 300, computer 110 may send a control command to controlled device 140 to switch on the lamp as shown in FIG. 16. A similar process may occur using the examples of locations in space including single point 1240, line 540, or area 740.

The actual command data sent to the controlled device may also be determined by the current state of the controlled device. Thus if the lamp is on, the controlled command may turn the lamp off and vice versa. In this regard, when the user 210 once again passes through the location in space including volume of space 840 (such as when user 210 leaves the room 300), this second occupation may be recognized, for example by depth camera 120, and another control command may be sent to controlled device 140. As a result, the controlled device 140 (the lamp) may be switched from on to off (shown again in FIG. 15).

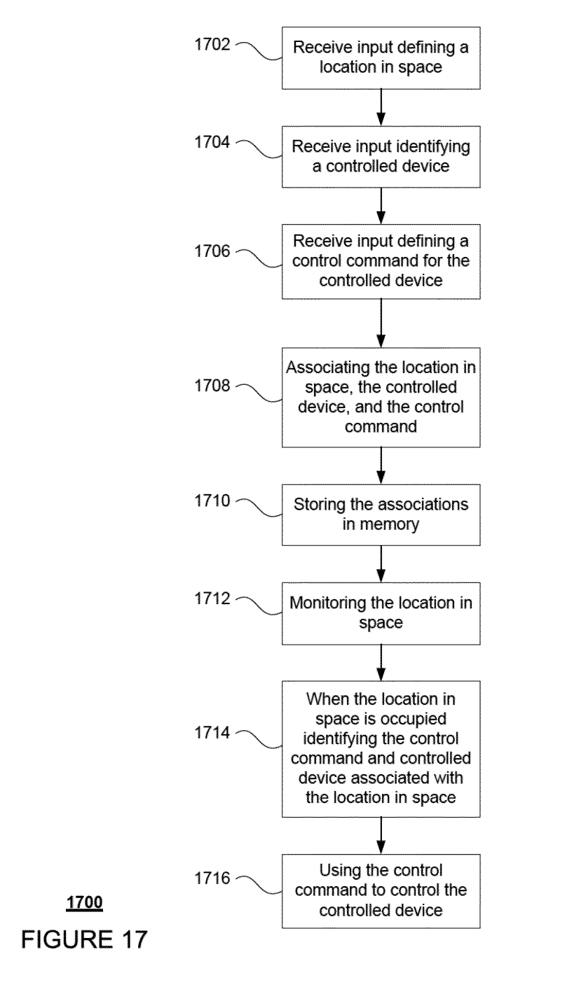

Flow diagram 1700 of FIG. 17 is an example of some of the aspects described above as performed by computer 110 and/or depth camera 120. In this example, input defining a location in space is received at block 1702. As noted above, a location in space may include for example, a single point, a line (between two points), two-dimensional areas or a 3-dimensional volume. Next, input identifying a controlled device is received at block 1704. In put defining a control command for the controlled device is also received at block 1206. The location in space, the controlled device, and the control command are associated with one another at block 1708, and the associations are stored in memory at block 1710.

The location in space is then monitored to determine when it is occupied at block 1712. When the location in space is occupied, the control command and controlled device associated with the location in space are identified at block 1714. The control command is then used to control the controlled device at block 1716.

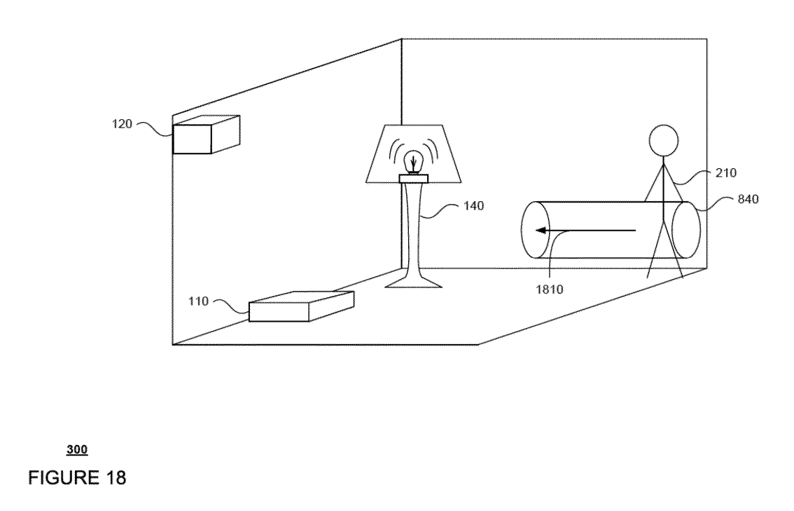

Instead of using a binary trigger (whether or not the location in space is occupied), more complex triggers may be used. For example, by moving through a location in space in a particular direction or at a particular point (if the location in space in not a single point), the computer 110 may adjust the setting of a feature of a device based on the control commands associated with that type of movement through that particular location in space. For example, depicted in the example of FIG. 18, as user 210 walks into room 300 and passes through location in space 840 the movement in the direction of arrow 1810 may be associated with a particular control commands that cause the lamp to become brighter the further along arrow 1810 user 210 moves. A similar process may occur using the examples of locations in space including single point 1240, line 540, or area 740. For example, the direction from which an object originates when it passes through a single point, line or area may be associated with a particular control command.

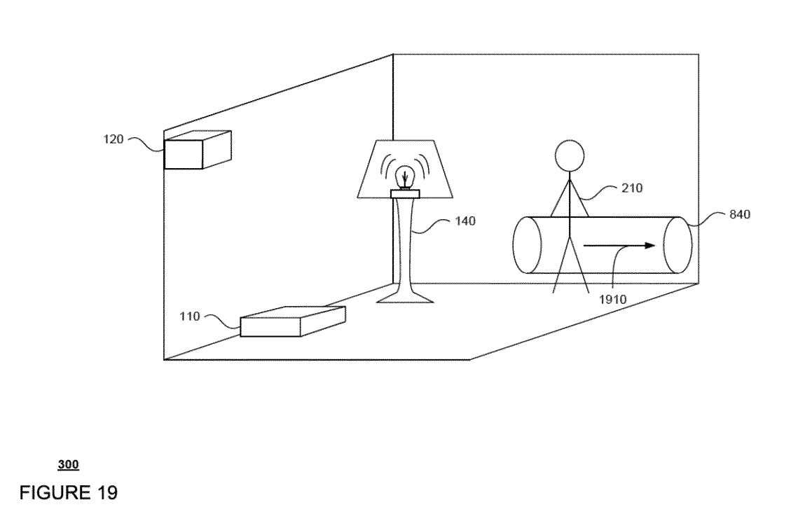

In addition, referring to the example of FIG. 19, as user as user 210 walks out of room 300 and passes through location in space 840 the movement in the direction of arrow 1910 may be associated with a particular control command that causes the lamp to become dimmer the further along arrow 1910 user 210 moves. In other examples, moving an object or user through a particular location in space in or from one direction may cause the volume of a device to increase, cause the speed of a fan to increase, etc. Similarly, the opposing movement may cause the opposite to occur, for example, decreasing the volume of a device, the speed of a fan, etc.

Rather than using the client device 130 to define the location in of space, other features may be used. For example, depth camera 130 may track an object having a particular color or characteristics, some feature of a person (hand, arm, etc.), some feature of a pet, etc. In these examples, the user 210 may be required to identify or select a controlled device as well as input the one or more control commands directly into computer 110. Thus, computer 110 may be a desktop computer, wireless-enabled PDA, hand-held navigation device, tablet PC, netbook, music device, or a cellular phone including user inputs and a display as with client device 130.

Rather than using the user inputs of client device 120 (or computer 110), a user may input information regarding when to start and stop recording a new location in space, the identification or selection of a controlled device, and/or associate the one or more control command by speaking into a microphone. The computer 110 may receive information from the microphone and use speech recognition tools to identify information.

The locations in space may also be defined by recording accelerometer and gyroscope and/or other sensor data at the client device. For example, a user may select an option to begin and end recording the data and subsequently send this information to computer 110 for processing. In this regard, the computer 110 need only rely on the depth camera 210 only for an initial localization of the client device 130 and may use the sensor data to define a volume of space.

In another example, locations in space may be defined without a client device at all. Rather, a user may use some predefined gesture vocabulary that can be recognized by the depth camera 210. For example, a user may hold up two fingers on his or her right hand to start defining a location in space (for example, replacing the client devices in the examples above, with such a gesture). A subsequent gesture, such as lowering the fingers, may be used as a signal to finish defining a location in space. Similarly, the user may then point at the object he or she wishes to control to establish the association between the location in space and a controlled device. Other gestures, for example using two hands, a single figure, or more than two fingers may also be used in a similar manner to define a location in space.

A combination of sensor date from the client device and gestures may also be used to define location in space. This may allow a user to initiate the recoding using a client device and tracking the hand holding the client device to define the locations in space. In this regard, the depth camera's hand tracking may be correlated to the sensor data in order to verify the tracked hand is actually the one defining the space). This eliminates the requirement that the depth camera 230 or computer 110 recognize the client device 130 directly.

In the examples above, the location in space are defined relative to a coordinate system of the depth camera. Alternatively, a location in space may be defined relative to a user's body or relative to a particular object. In these examples, the user's body or objects may be moved to different places in the room.

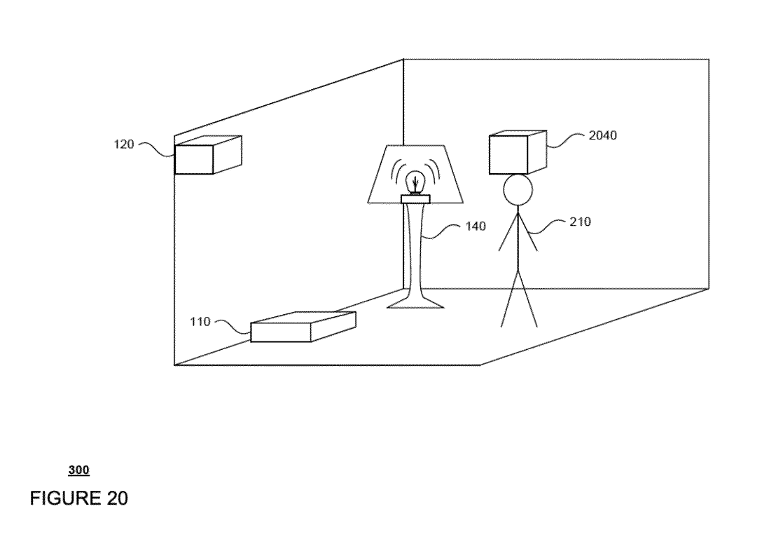

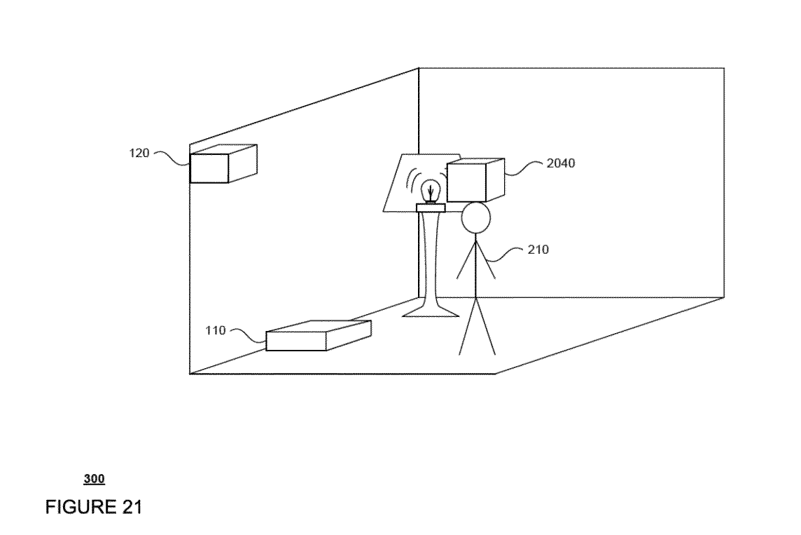

A particular object or a user's body may be recognized using object recognition software which allows computer 110 and/or depth camera 120 to track changes in the location of the particular object or body. Any relevant location in space may be moved relative to the object accordingly. FIGS. 20 and 21 demonstrate this concept using a three-dimensional volume of space, although a similar concept may be used in conjunction with a single point, line, or two-dimensional area. In FIG. 20, user 210 is associated with a location in space including a cube 2040 above the user's head. As user 210 moves to another location in room 300, the location in space including cube 2040 moves with the user as shown in FIG. 21.

In yet other examples, the location in space and/or the control commands may be associated with a particular user. For example, the computer may use facial recognition software to identify who a user is and identify that user's personal volumes of space and/or control commands. Returning to the example of FIG. 11, volume of space 210 may be associated only with user 210 and user 210's control commands. When user 210's walks through a location in space such as those including single point 1240, line 540, two-dimensional area 740, or three-dimensional volume of space 840, computer 110 may turn the controlled device 140 on and off. However, if another user walks through volume of space, but the computer 110 determines that it is not user 210, the computer 110 will not use user 210's control commands to control the controlled device 140. Thus, the light 140, referring to of FIG. 15 or 16, may not be turned on or off.

In another example, the location in space may be associated with multiple sets of control commands for different user. In this regard, a second user's control command associated with a location in space may cause a fan to turn on or off. Thus, if user 210 walks through a location in space, computer 110 may turn the controlled device 140 (the light) may turn on and off, and if the second user walks though the same location in space, computer may turn a fan on or off.

As these and other variations and combinations of the features discussed above can be utilized without departing from the subject matter defined by the claims, the foregoing description of the embodiments should be taken by way of illustration rather than by way of limitation of the subject matter defined by the claims. It will also be understood that the provision of the examples described herein (as well as clauses phrased as “such as,” “including” and the like) should not be interpreted as limiting the invention to the specific examples; rather, the examples are intended to illustrate only one of many possible embodiments. Further, the same reference numbers in different drawings may identify the same or similar elements.

1. A method comprising:
receiving input defining a location;
receiving input identifying a controlled device;
receiving input defining a control command for the controlled device;
associating the location, the controlled device, and the control command;
storing the association in memory;
receiving information identifying the location, the received information indicating that the location is newly occupied by an object;
in response to the received information, accessing the memory to identify the control command and the controlled device associated with the location; and
using, by a processor, the control command to control the controlled device.

2. The method of claim 1, wherein the location includes only a single point in three-dimensional space and the method further comprises monitoring the single point to determine when the single point is occupied by the object.

3. The method of claim 1, wherein the location includes a line defined by two points and the method further comprises monitoring the line defined by the two points to determine when the line defined by the two points is occupied by the object.

4. The method of claim 1, wherein the location includes a two-dimensional area and the method further comprises monitoring the two-dimensional area to determine when the single point is occupied by the object.

5. The method of claim 1, wherein the location is defined by receiving input to capture a single point in three-dimensional space.

6. The method of claim 1, wherein the location is defined by:
receiving input to capture a first point and a second point; and
drawing a line between the first point and the second point to define the location.

7. The method of claim 1, wherein the location is defined by:
receiving input to capture a first point, a second point, and a third point; and
drawing an area using the first point, the second point, and the third point to define the location.

8. The method of claim 1, wherein the input defining the location is received from a depth camera.

9. The method of claim 8, wherein the location is defined relative to a coordinate system of the depth camera.

10. The method of claim 8, wherein the location is defined relative to an object other than the depth camera such that if the object is moved, the location with respect to the depth camera is moved as well.

11. The method of claim 8, wherein the object includes at least some feature of a user's body.

12. A system comprising:
memory;
a processor configured to:
receive input defining a location;
receive input identifying a controlled device;
receive input defining a control command for the controlled device;
associate the location, the controlled device, and the control command;
store the association in the memory;
receive information identifying the location, the received information indicating that the location is newly occupied by an object;
in response to the received information, access the memory to identify the control command and the controlled device associated with the location; and
use the control command to control the controlled device.

13. The system of claim 12, wherein the location includes only a single point in three-dimensional space and the processor is further configured to monitor the single point to determine when the single point is occupied by the object.

14. The system of claim 12, wherein the location includes a line defined by two points and the processor is further configured to monitor the line defined by the two points to determine when the line defined by the two points is occupied by the object.

15. The system of claim 12, wherein the location includes a two-dimensional area and the processor is further configured to monitor the two-dimensional area to determine when the single point is occupied by the object.

16. The system of claim 12, wherein the processor is configured to define the location by receiving input to capture a single point in three-dimensional space.

17. The system of claim 12, wherein the processor is further configured to define the location by:
receiving input to capture a first point and a second point; and
drawing a line between the first point and the second point to define the location.

18. The system of claim 12, wherein the processor is further configured to define the location by:
receiving input to capture a first point, a second point, and a third point; and
drawing an area using the first point, the second point, and the third point to define the location.

19. A non-transitory, tangible computer-readable storage medium on which computer readable instructions of a program are stored, the instructions, when executed by a processor, cause the processor to perform a method, the method comprising:
receiving input defining a location;
receiving input identifying a controlled device;
receiving input defining a control command for the controlled device;
associating the location, the controlled device, and the control command;
storing the association in memory;
receiving information identifying the location, the received information indicating that the location is newly occupied by an object;
in response to the received information, accessing the memory to identify the control command and the controlled device associated with the location; and
using the control command to control the controlled device.
